(19) United States
(12) Patent Application Publication
(10) Pub. No.: US 2026/0310903 A1
(43) Pub. Date: Oct. 8, 2026

(54) SYSTEMS AND METHODS FOR DETECTING AND REDUCING HALLUCINATIONS IN LARGE LANGUAGE MODELS

(71) Applicant: FMR LLC, Boston, MA (US)

(72) Inventors: Shrikumar Rajendra PATIL, Boston, MA (US); Preethi RAGHAVAN, Belmont, MA (US); Amrit GUPTA, Seattle, WA (US); Luiz Penna Costa FREITAS, Cambridge, MA (US); Brian Gilbert HURLEY, Needham, MA (US); Sorin Adrian ROMAN, Hampton Falls, NH (US)

(21) Appl. No.: 19/170,579

(22) Filed: Apr. 4, 2025

(51) Int. Cl. G06F 40/40

(52) U.S. Cl. CPC G06F 40/40

(57) ABSTRACT

Systems and methods are described for reducing hallucinations in large language models (LLM). A user may provide a prompt to an LLM, which generates a response based on the prompt and one or more content items that are determined to be relevant to the prompt. Next, one or more consistency measurement models generate corresponding scores that relate to the factual consistency of the response. A scoring machine learning model may generate a final score based on the aforementioned scores. In case that the final score does not reach a predetermined threshold, error correction is performed on the response. In case that the final score does reach the predetermined threshold, the response is evaluated for its quality and completeness.

### TECHNICAL FIELD

This application relates generally to systems and methods, including computer program products, for reducing hallucinations in large language models.

### BACKGROUND

Hallucinations which refer to instances in which a generative artificial intelligence (AI) model generates answers to questions (in the form of prompts by a user) that are factually inconsistent, misleading, includes fabricated information, or is otherwise false. As is evident this is a problem, since hallucinated answers can lead to spread of misinformation, thereby leading to possibly harmful consequences. Further, hallucinations are not the only problem with generative AI models. There may be a completeness problem as well. More specifically, the answers generated by the generative AI models may be correct, but may omit certain importation information or may not completely answer the question. Likewise, there may also be a quality issue as well. The answers generated by the generative AI models may be correct, but may be too long and include unnecessary information, therefore decreasing the practicality of using the generate AI models to answer questions. As such, there remains a need for a way to have a generative AI model generate complete and concise answers without any hallucinations.

### SUMMARY

The present disclosure, in one aspect, a computing system for determining accuracy of natural language responses generated by a machine learning model, the system comprising a server computing device having memory for storing computer-executable instructions and a processor that executes the computer-executable instructions to: generate, by a generative machine learning model, a response, in the natural language, to a user prompt from a user, wherein the generated response is generated based on the user prompt and one or more content items, and wherein the one or more content items are determined by a retrieval machine learning model to be relevant to the user prompt; generate, via two or consistency more machine learning models, two or more consistency scores, wherein the two or more consistency scores are each generated by a different consistency machine learning model based on at least one of the user prompt, the response, and the one or more content items, wherein each consistency score represents a different consistency measurement of the response according to the respective consistency machine learning model; generate, via a scoring machine learning model, a final consistency score based on the two or more consistency scores; and determine that the response is accurate in the case that the final consistency score is greater than or equal to a consistency predetermined threshold.

The computer-executable instructions cause the processor to perform further operations to: generate, via a completeness machine learning model, a completeness score based on the user prompt, the response, and the one or more content items, wherein the completeness score represents the extent to which the response addresses the user prompt in view of the one or more content items; and transmit the response to the user in a case that the completeness score is equal to or greater than a completeness predetermined threshold. The completeness score is measured via a scoring rubric, in which the scoring rubric includes one or more rubric scores that indicate the degree to which the response addresses the user prompt, and wherein a maximum rubric score on the scoring rubric indicates that a response completely addresses a user prompt in view of relevant one or more content items.

The completeness machine learning model is trained using a training dataset that includes reference content items, one or more prompts corresponding to the one or more reference content items, and one or more incomplete answers that each correspond to a complete answer to a prompt of the one or more prompts, wherein each incomplete answer is generated by removing one or more contiguous sentences in a respective complete answer. The completeness machine learning model includes at least one of Large Language Model Meta AI (Llama) 2 and Mistral. The machine learning model is fine-tuned using at least one of Parameter-Efficient Fine-Tuning (PEFT) and Quantized Low Rank Adapters (QLoRA).

In a case that the final consistency score is less than a consistency predetermined threshold, the computer-executable instructions cause the processor to perform further operations to: generate, via an error correcting machine learning model, a corrected response based on the edited response and the one or more content items, wherein the corrected response corrects one or more errors in the edited response; and transmit the corrected response to the user. The error correcting machine learning model is trained using a training dataset that includes one or more reference content items, one or more prompts that correspond to the one or more reference content items, and one or more erroneous answers that each correspond to a correct answer to a prompt of the one or more prompts, and wherein each of the one or more erroneous answers are generated based by modifying the respective correct answer to include one or more errors.

Modifying the respective correct answer to include one or more errors comprises at least one of insertion of words, deletion of one or more words, replacement of one or more words, and swaps of one or more words. The modification of the respective correct answer to include one or more errors is performed by prompting at least one of a language model or a large language model to generate a hallucinated or factually inconsistent answer based on the correct answer. The computer-executable instructions cause the processor to perform further operations to: generate, via a quality control machine learning model, a quality score based on the user prompt, the response, and the one or more content items, wherein the quality score represents the quality of the response in view of the user prompt and the one or more content items; and transmit the response to the user in a case that the completeness score is equal to or greater than a completeness predetermined threshold. The quality control machine learning model determines the quality of the response based at least one of whether the response is relevant to the user prompt in view of the one or more content items, whether the response is concise, whether important entities in the one or more content items are included within the response, and whether response includes correct grammar.

The present disclosure, in another aspect, features a computerized method for determining accuracy of natural language responses generated by a machine learning model, the method comprising: generating, by a server computing device using a generative machine learning model, a response, in the natural language, to a user prompt from a user, wherein the response is generated based on the user prompt and one or more content items, and wherein the one or more content items are determined by a retrieval machine learning model to be relevant to the user prompt; generating, by the server computing device using two or consistency more machine learning models, two or more consistency scores, wherein the two or more consistency scores are each generated by a different consistency machine learning model based on at least one of the user prompt, the response, and the one or more content items, wherein each consistency score represents a different consistency measurement of the response according to the respective consistency machine learning model; generating, by the server computing device using a scoring machine learning model, a final consistency score based on the two or more consistency scores; and determining, by the server computing device, that the response is accurate in the case that the final consistency score is greater than or equal to a consistency predetermined threshold.

The retrieval machine learning model uses the retrieval augmented generation (RAG) technique in retrieving the one or more content items from a content database. At least one of the two or more consistency machine learning models determines a consistency score by: determining whether it is possible to generate an answer to the user prompt; generating a test response based on the user prompt and the one or more content items after determining that it is possible to generate an answer to the user prompt; and generating the consistency score based on an overlap measurement that represents the amount of overlap between the response and the test response. At least one of the two or more consistency machine learning models determines a consistency score by: determining the longest common subsequence between the response and the one or more content items, wherein the longest commons subsequence includes the longest sequence of words that are present in both the response and the one or more content items; generating a precision metric and a recall metric based on the longest common subsequence and the total number of words in the response and the total number of words in the one or more content items; and generating the consistency score based on a harmonic mean of the precision metric and the recall metric.

At least one of the two or more consistency machine learning models determines a consistency score by: generating a matrix that includes, for each element in the matrix, an entailment score that corresponds to one or more combinations of sentences in the response and the one or more content items, wherein the rows of the matrix correspond to one or more sentences in the one or more content items and the columns of the matrix correspond to one or more sentences in the response, and wherein each combination includes a sentence from the response and a sentence from the one or more content items; determining a maximum score set that includes a maximum score for each column in the matrix; and generating a consistency score based on the average of the maximum scores in the maximum score set.

At least one of the two or more consistency machine learning models determines a consistency score by: dividing the one or more content items into one or more chunks; dividing the response into one or more sentences; generating one or more alignment scores for one or more combinations of the one or more chunks and the one or more individual sentences, wherein each combination includes a chunk from the one or more chunks and a sentence from the one or more individual sentences, and wherein each alignment score is generated by inputting an alignment machine learning model with a respective combination; and generating the consistency score based on the average of the one or more alignment scores.

At least one of the two or more consistency machine learning models determines a consistency score by: generating, by the generating machine learning model, a parametric response based on the user prompt and parametric knowledge stored in the generating machine learning model; generating a first similarity score that represents the similarity between the response and the one or more content items and a second similarity score that represents the similarity between the parametric response and the one or more content items; and generating the consistency score based on a difference between the first similarity score and the second similarity score.

The two or more consistency machine learning models includes at least one of Bidirectional and Auto-Regressive Transformers (BART), Text-to-Text Transfer Transformer (T5), Source Chunking Approach for Large-Scale Inconsistency Evaluation (SCALE), Summary Consistency Detection (SummaC), and AlignScore. The scoring machine learning model is configured to generate a final score that includes a numerical value that is between zero and one. The scoring machine learning model is a binary classification model that uses at least one of the following algorithms: naïve Bayes, logistic regression, k-nearest neighbors, support vector machine, decision tree, and neural networks. At least one of the retrieval machine learning model, the generative machine learning model, and the two or more consistency machine learning models includes at least one of a language model or a large language model. The generative machine learning model includes at least one of ChatGPT, CoPilot, Gemini, Claude, Mistral, Llama, and Phi.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system reducing hallucinations in machine learning models.

FIG. 2 is a flow diagram of a computerized method for reducing hallucinations in machine learning models.

FIG. 3 is an example diagram of a prompt that is provided to a quality evaluating machine learning model to cause the machine learning model to perform a quality evaluation of a response generated by a generating machine learning model.

FIG. 4 is an example diagram of an architecture for generating an answer by an LLM based on a user query and relevant documents obtained from a document database using a retrieval-augmented generation (RAG) system.

FIG. 5 is an example diagram of an architecture for reducing hallucinations in answers generated by an LLM.

FIG. 6 is a flow diagram of a computerized method for training an error correcting machine learning model to perform error correction.

FIGS. 7A-7D are example diagrams of a training item that is used for training an error correcting machine learning model to perform error correction, in which the training item includes a query, an answer, a relevant content item, and an edited answer.

FIG. 7E is an example diagram of an annotated correct answer that may be generated by the error correcting machine learning model during inference time.

FIG. 8 is a flow diagram of a computerized method for training a completeness machine learning model to evaluate completeness.

FIG. 9 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

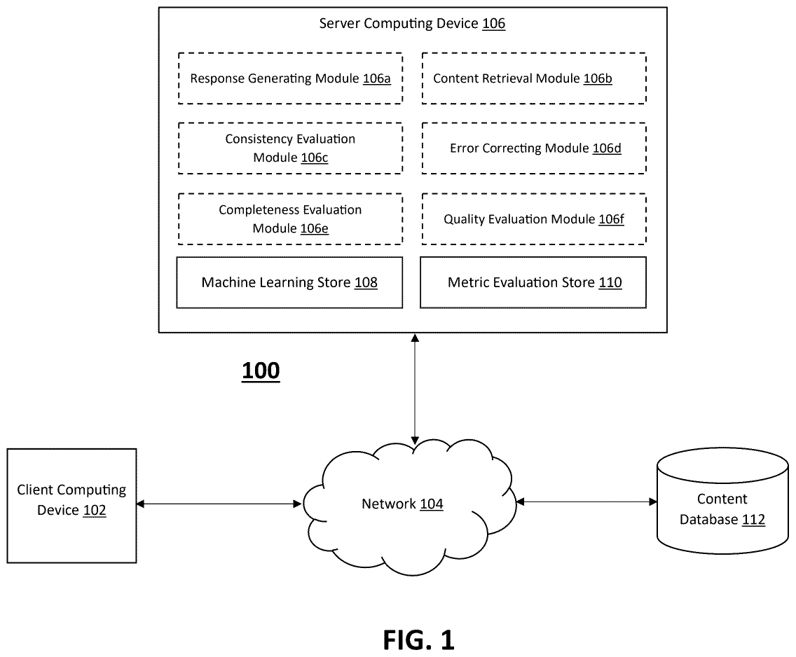

FIG. 1 is a block diagram of a system for 100, which includes a client computing device 102, a server computing device 106, and a content database 112, all of which are capable of communicating with each other via a communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing device 102 include but is not limited to desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, and to receive data from other components of the system 100, as described herein. The server computing device 106 includes several systems, frameworks, stores, and computing modules that execute on one or more processors of the server computing device 106. For example, the server computing device 106 includes a content retrieval module 106a, a response generating module 106b, a consistency evaluation module 106c, a completeness evaluation module 106d, an error correcting module 106e, a quality evaluation module 106f, and a machine learning store 108 (which can store all types of machine learning models, such as classification type machine learning model(s), regression type machine learning model(s), support vector machines (SVM) machine learning model(s), ensemble method machine learning model(s), neural network model(s), recurrent neural networks (e.g., long short term memory), deep learning model(s), or (large) language model(s)). In some embodiments, the content retrieval module 106a, the response generating module 106b, the consistency evaluation module 106c, the completeness evaluation module 106d, the error correcting module 106e, the quality evaluation module 106f, and the machine learning store 108 are specialized sets of computer software instructions programmed onto one or more dedicated processors in server computing device 106 and can include specifically-designated memory locations and/or registers for executing the specialized computer software instructions.

Although the content retrieval module 106a, the response generating module 106b, the consistency evaluation module 106c, the completeness evaluation module 106d, the error correcting module 106e, the quality evaluation module 106f, and the machine learning store 108 are shown in FIG. 1 as executing within the same server computing device 106, in some embodiments the functionality of the content retrieval module 106a, the response generating module 106b, the consistency evaluation module 106c, the completeness evaluation module 106d, the error correcting module 106e, the quality evaluation module 106f, and the machine learning store 108 can be distributed among a plurality of server computing devices. As shown in FIG. 1, the server computing device 106 allows the content retrieval module 106a, the response generating module 106b, the consistency evaluation module 106c, the completeness evaluation module 106d, the error correcting module 106e, the quality evaluation module 106f, and the machine learning store 108 to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the content retrieval module 106a, the response generating module 106b, the consistency evaluation module 106c, the completeness evaluation module 106d, the error correcting module 106e, the quality evaluation module 106f, and the machine learning store 108 are described in detail below.

The content database 112 is a computing device (or, in some embodiments, may be a set of computing devices) that is configured to provide, receive and store various types of content items. A content item may include information (e.g., in electronic format) that can be presented for viewing and/or listening by a user. For example, the content items may be in the format of text, images, audio, video, or a combination thereof. In some embodiments, one or more of the content items may be directed to the same field or subject matter (e.g., science, entertainment, medical, law, business, etc.) or the same topic (e.g., top movies of the year, best cities to live in, descriptions of birds in North America, etc.).

### Example Routine for Reducing Hallucinations in Machine Learning Models

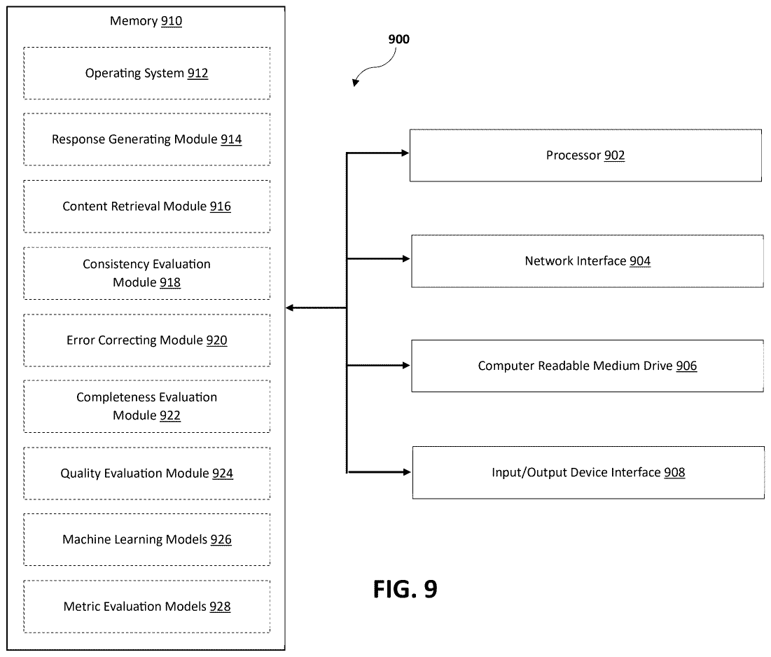

When a routine described herein (i.e., 200, 600, 800) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 900 shown in FIG. 9, and executed by one or more processors. In some embodiments, the routine 200, 600, 800, or portions thereof may be implemented on multiple processors, serially or in parallel.

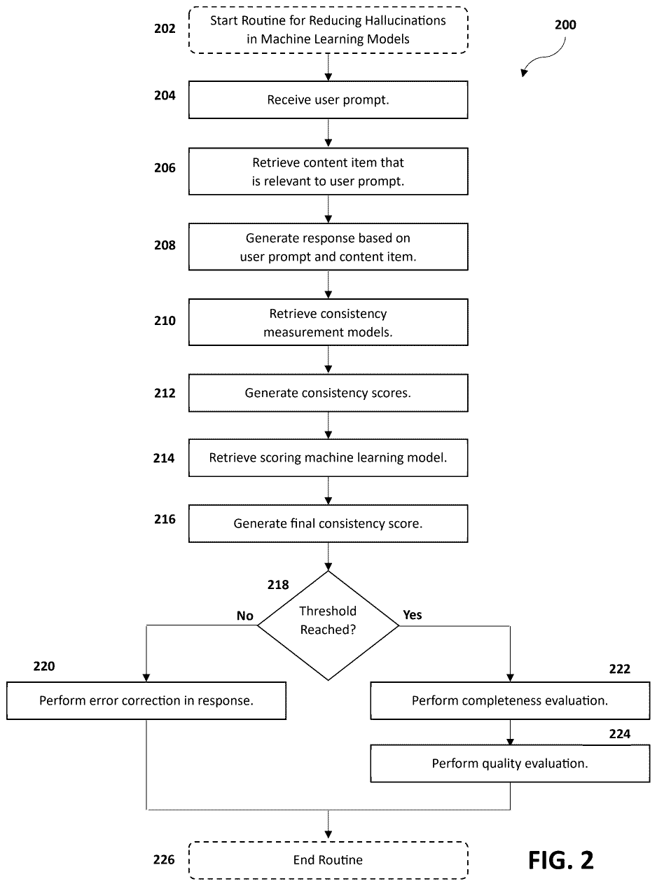

FIG. 2 illustrates example routine 200 (beginning at block 202) for reducing hallucinations in machine learning models, that is performed, for example, by one or more modules in the server computing device 106 (e.g., response generating module 106a, content retrieval module 106b, consistency evaluation module 106c, completeness evaluation module 106d, error correcting module 106e, quality evaluation module 106f). At block 204, the response generating module 106a may receive a user prompt (e.g., “Which department can I contact for statuses on wires, checks, EFTs?”), which, for example, may be in a natural language format. More specifically, the user prompt may be input (e.g., entered) into a user interface provided in connection with the response generating module 106a. After receiving the user prompt, the response generating module 106a may transmit the user prompt to the content retrieval module 106b.

At block 206, the content retrieval module 106b may retrieve one or more content items that are relevant to the user prompt. More specifically, the content retrieval module 106b may access, for example, the content database 112, which includes one or more content items. As discussed previously, a content item may include information (e.g., in electronic format) that can be presented for viewing and/or listening by a user. For example, the content items may be in the format of text, images, audio, video, or a combination thereof. In some embodiments, one or more of the content items may be directed to the same field or subject matter (e.g., science, entertainment, medical, law, business, etc.) or the same topic (e.g., top movies of the year, best cities to live in, descriptions of birds in North America, etc.).

After accessing the content database 112, the content retrieval module 106b may determine which of the content items stored in the content database 112 are relevant to the user prompt. To perform such determination, the content retrieval module 106b may first convert the user prompt into embeddings or vectors using one or more word embedding algorithms, such as word2vec (as described in T. Mikolov et al., “Efficient Estimation of Word Representations in Vector Space,” arXiv:1301.3781v3 [cs.CL] 7 Sep. 2013, incorporated herein by reference) or GloVe (as described in J. Pennington et al., “GloVe: Global Vectors for Word Representation,” Proceedings of the 2014 Conference on Empirical Methods in Natural Language Processing (EMNLP), October 2014, pp. 1532-1543, incorporated herein by reference).

More specifically, embeddings are words represented according to a multidimensional vector (e.g., a word may be represented by a single row or column vector having fifty numbers as elements of the vector). A machine learning model (configured for embedding) or SentenceTransformers (which is a Python framework for state-of-the-art sentence, text and image embeddings.) may have been trained to determine how to convert a word or sentence into an embedding, and may generate a list pairing each word to its corresponding vector equivalent or may convert the entire sentence into a single representation (e.g., its corresponding vector equivalent), which may preserve (and/or represent) contextual information in the embedding. As such, in some embodiments, the converting of the word or sentence into an embedding may not necessarily require such machine learning model configured for embedding (or the SentenceTransformers). Instead, a simple algorithm for matching words or sentences to predefined vectors may be used.

Afterwards, the content retrieval module 106b determines the semantic similarity between the embedded user prompt and the one or more embedded content items that are stored in the content database 112. It should be noted that the embeddings allow a machine learning model (e.g., LLM) to more efficiently distinguish or recognize relationships between words. This is in part because the embeddings are numerical values, which are more easily understood (and processable) by the machine learning model. In some embodiments, the content database 112 stores both the one or more content items and the embeddings corresponding to the one or more content items (e.g., one or more embedded contents). In other words, each of the one or more content items in the content database 112 may have already been converted into embeddings or vectors using a machine learning model or one or more of the aforementioned word embedding algorithms.

In other embodiments, the content database 112 may store the one or more content items without any embeddings corresponding to the one or more content items. In other words, to determine the semantic similarity of the user prompt and the one or more content items, the content retrieval module 106b may convert each of the one or more content items into an embedding or vector. For example, the content retrieval module 106b may utilize a simple algorithm for matching words or sentences to predefined vectors to perform such converting into an embedding or vector. In another example, the content retrieval module 106b may utilize an embedding machine learning model (e.g., LLM) that is retrieved (e.g., by the content retrieval module 106b) from, for example, the machine learning store 108. The content retrieval module 106b may utilize such embedding machine learning model (which is pre-trained to generate embeddings) to convert each of the one or more content items into an embedding or vector.

An example of a technique to determine semantic similarity (e.g., determine by the content retrieval module 106b) between words is using a measurement function (e.g., a heuristic quantification method of keyword matching), such as cosine similarity, Euclidean distance, Manhattan distance, Jaccard similarity, and Minkowski distance. Cosine similarity may be determined by taking the division between the dot product of vectors and the product of the Euclidean norms or magnitude of each vector. The resulting cosine similarity score may range from zero to one, with a score closer to one indicating higher semantic similarity between the two words (e.g., “King” and “Man” have a score of 0.98), and a score closer to zero indicating lower semantic similarity between the two words (e.g., “King” and “car” have a score of 0.14).

Consequently, the content retrieval module 106b may determines one or more content items that are relevant to the user prompt by determining the semantic similarity between the embedded user prompt and the one or more embedded content items based on the aforementioned methods (e.g., cosine similarity). After retrieving the one or more relevant content items, the content retrieval module 106b transmits the one or more relevant content items to the response generating module 106a.

At block 206, the response generating module 106a generates a response (in a natural language format) based on the user prompt and the one or more relevant content items. More specifically, the response generating module 106a may generate a response by using a generating machine learning model (e.g., LLM). The generating machine learning model may, for example, include at least one of ChatGPT (Chat Generative Pre-Trained Transformer), CoPilot, Gemini, Claude, Mistral, Llama, and Phi. For example, the response generating module 106a may retrieve the generating machine learning model from the machine learning store 108. After retrieving the generating machine learning model from the machine learning store 108, at block 208, the response generating module 106a may input the user prompt and the one or more relevant content items into the generating machine learning model, which generates (and outputs) a response based on the user prompt and the one or more relevant content items.

At block 210, the consistency evaluation module 106c retrieves one or more consistency measurement models from, for example, the machine learning store 108 and/or the metric evaluation store 110. For example, the metric evaluation store 110 may store metric evaluation models, which are models that determine a (factual) consistency of generated response via techniques that do not involve artificial intelligence (AI) or machine learning. More specifically, after the response generating module 106a has generated (e.g., via the generating machine learning model) a response based on the one or more relevant content items, the response generating module 106a may transmit the generated response to the consistency evaluation module 106c. The consistency evaluation module 106c may be configured to determine whether the response generated by the generating machine learning model, that is utilized by the response generating module 106c, is factually correct.

Factual errors may occur when the generated response includes misinformation, myths, or outdated information. For example, factual errors may include entity errors (e.g., contradictory entities or hallucinated entities), contradictory statements, negation errors (e.g., generated answer includes the opposite of what was queried; prompt: “What are some fruits that are not red?”, response: “apples, cherries, strawberries”), and unverifiable errors from extraneous information in the generated response (e.g., the extraneous information is coherent with the topic or context of the query or prompt but includes one or more pieces of information that cannot be verified).

At block 212, to facilitate such determination (e.g., of whether the generate response includes factual errors), the consistency evaluation module 106c may input the generated response and the one or more relevant documents (e.g., previously retrieved by the content retrieval module 106b) into each of the consistency measurement models. In turn, each of the consistency machine learning models may generate a consistency score that indicates how factually consistent the generated answer is. In some embodiments, the consistency measurement models may include one or more consistency machine learning models that are stored in the machine learning model 108. In some embodiments, the consistency measurement models may include one or more metric evaluation models that are stored in the metric evaluation store 110.

In some embodiments, one of the consistency measurement models may include a QA (question-answering) machine learning model (e.g., language model or LLM) that is capable of generating answers to a query in a user prompt (as described in A. Fabbri et al., “QAFactEval: Improved QA-Based Factual Consistency Evaluation for Summarization,” arXiv:2112.08542v2 [cs.CL] 29 Apr. 2022, incorporated herein by reference). For example, such QA machine learning model may be stored in the machine learning store 108 (and retrieved from the machine learning store 108 by the consistency evaluation module 106c). It should be noted that the query in the user prompt may be in the form of a question. It should also be noted that that the query in the user prompt may be in the form other than a question, such as, for example, the imperative mood (e.g., “Please give me a description of the habitats and lifestyle of the pygmy hippo”).

One example of such QA machine learning model is BART (e.g., Bidirectional and Auto-Regressive Transformer), which includes a bidirectional encoder and an autoregressive decoder for its architecture. Another example of such QA machine learning model is a Text-to-Text Transfer Transformer (“T5”) model (as described in C. Raffel et al., “Exploring the Limits of Transfer Learning with a Unified Text-to-Text Transformer,” arXiv:1910.10683v4 [cs.LG] 19 Sep. 2023, incorporated herein by reference). For example, a T5 model can be fine-tuned to classify, in a binary format (e.g., 1 or 0, true or false, etc.) whether there is hallucination, provided a reference context and LLM generation.

More specifically, the QA machine learning model may be instructed (e.g., via a prompt) to determine whether the query in the user prompt can be answered (or not). The QA machine learning model may also be instructed (e.g., via the prompt) to generate a test response based on the query in the user prompt and the one or more relevant content items after determining that it is possible to generate an answer to the query in the user prompt. The QA machine learning model may further be instructed (e.g., via the prompt) to generate a consistency score based on an overlap measurement between the generated response (e.g., generated by generating machine learning model as utilized by the response generating module 106a) and the test response (e.g., generated by QA machine learning model as utilized by the consistency evaluation module 106c).

In some embodiments, the overlap measurement may be an exact match (EM) technique. More specifically, the exact match technique generates a binary outcome (e.g., 1 or 0) depending on whether there is an absolute or complete correspondence between the generated response and the test response. In case that the generated response exactly matches (e.g., is the same) the test response, the binary outcome is one. In case that the generated response does not exactly match (e.g., is different) the test response, the binary outcome is zero. Consequently, the value of the binary outcome (e.g., one or zero) may be considered the consistency score.

In other embodiments, the overlap measurement may be an F1 score technique. More specifically, the F1 score technique is determined based on the harmonic mean of a precision metric and a recall metric. The precision metric indicates an accuracy of positive predictions and is determined by dividing the number of true positive predictions by the total number of positive predictions (true positives+false positives). The recall metric indicates how well a machine learning model (e.g., generating machine learning model of response generating module 106a) can identify actual positive cases, and is determined by dividing a number of true positive predictions by the total number of actual positive instances (true positives+false negatives).

In some embodiments, one of the consistency measurement models may include a ROUGE-L (Recall-Oriented Understudy for Gisting Evaluation—Longest Common Subsequence) technique (as described in Chin-Yew Lin, “ROUGE: A Package for Automatic Evaluation of Summaries,” Proceedings of Workshop on Text Summarization Branches Out, Post-Conference Workshop of Association for Computational Linguistics (ACL) 2004 (Barcelona, Spain), July 2004, pp. 74-81, incorporated herein by reference), which may be a metric evaluation model. For example, the ROUGE-L technique may be stored in the metric evaluation store 110 (and retrieved from the metric evaluation store 110 by the consistency evaluation module 106c). The ROUGE-L technique may be performed by first dividing each of the generated response and the one or more relevant content items into words or n-grams (where n is a natural number or integer greater than zero). Then, the longest common subsequence is determined based on the total number of word (or n-grams) matches between the generated response and the one or more relevant content items. The ROUGE-L precision is then determined by obtaining the ratio of the length of the longest common subsequence over the total number of words (or n-grams) in the user prompt. Similarly, the ROUGE-L recall is then determined by obtaining the length of the longest common subsequence over the total number of words (or n-grams) in the one or more relevant content items. The ROUGE-L F1 score is then determined by obtaining the value of ROUGE-L harmonic mean of the ROUGE-L precision and the ROUGE-L recall. Consequently, the value of the binary outcome (e.g., one or zero) may be considered the consistency score.

In some embodiments, one of the consistency measurement models may include a SummaC (Summary Consistency) technique (as described in P. Laban et al., “SUMMAC: Re-Visiting NLI-based Models for Inconsistency Detection in Summarization,” arXiv:2111.09525v1 [cs.CL] 18 Nov. 2021, incorporated herein by reference) involving a SummaC machine learning model (which may be pretrained). For example, such SummaC machine learning model may be stored in the machine learning store 108 (and retrieved from the machine learning store 108 by the consistency evaluation module 106c). Facilitating the SummaC technique involves generating a matrix that includes, for each element in the matrix, an entailment score that corresponds to one or more combinations of sentences in the generated response and the one or more relevant content items.

In other words, because the generated response may include one or more sentences and the one or more relevant content items may include one or more sentences, each row of the matrix corresponds to a single sentence of the one or more relevant content items and each column of the matrix corresponds to a single (different) sentence of the generated response. Consequently, each element of the matrix includes an entailment score (determined by the SummaC machine learning model) that represents whether a column (or row) sentence logically follows from a row (or column) sentence (e.g., whether a sentence in the generated response logically follows from a sentence in the one or more relevant content items).

After determining the entailment score for each element in the matrix, a maximum score is determined for each column in the matrix. The maximums scores are then included in a maximum score set. In other words, there may be multiple entailment scores in a column of the matrix. Therefore, the entailment score having the highest value (as compared to the other entailment scores in the column) is selected to be included in the maximum score set. The consistency score is then generated by determining the average of the maximum scores in the maximum score set (e.g., the value may be between zero and one).

In some embodiments, one of the consistency measurement models may include an AlignScore technique (as described in S. Zha et al., “ALIGNSCORE: Evaluating Factual Consistency with A Unified Alignment Function,” arXiv:2305.16739v1 [cs.CL] 26 May 2023, incorporated herein by reference) involving an AlignScore machine learning model (which may be pretrained). The AlignScore machine learning model may be a transformer-based model with is trained on binary entailment tasks. For example, such AlignScore machine learning model may be stored in the machine learning store 108 (and retrieved from the machine learning store 108 by the consistency evaluation module 106c). Facilitating the AlignScore technique involves first dividing the one or more relevant content items into one or more chunks. For example, each chunk may correspond to an (different) individual sentence in the one or more relevant content items. In another example, each chunk may correspond to a (fixed) predetermined number of tokens (e.g., 350) such as words. Next, the generated response is divided into one or more sentences.

Then, each sentence in the generated response is paired with each chunk of the one or more relevant content items to generate an AlignScore combination. In other words, each sentence in the generated response is compared to each (e.g., all) of the chunks corresponding to the one or more relevant content items (e.g., similar to a mathematical combination). Afterwards, the one or more AlignScore combinations are input into the AlignScore machine learning model, which then determines an alignment score for each of the one or more AlignScore combinations. A consistency score is then generated based on the average of the one or more alignment scores (that were determined by the AlignScore machine learning model).

In some embodiments, one of the consistency measurement models may include a faithfulness evaluation technique. For example, the faithfulness evaluation technique may be stored in the metric evaluation store 110 (and retrieved from the metric evaluation store 110 by the consistency evaluation module 106c). The faithfulness evaluation technique may be performed by first retrieving (e.g., via the consistency evaluation module 106c) the generating machine learning model (e.g., ChatGPT (Chat Generative Pre-Trained Transformer), CoPilot, Gemini, and Claude) from, for example, the machine learning store 108. The generating machine learning model may have been previously used by the response generating module 106a to generate the generated response.

The generating machine learning model then generates a parametric response based on the user prompt (e.g., received in block 204 of routine 200) and the parametric knowledge stored in the generating machine learning model. The parametric knowledge may be the internalized understanding that a machine learning model gains from training on a dataset. Such parametric knowledge may be represented by the parameters (weights and biases) of the generating machine learning model, which are adjusted during the training process to minimize the loss function and improve the performance of the generating machine learning model. It should be noted that parametric knowledge allows the generating machine learning model to generate predictions and generalize to new and unseen data by capturing essential features and relationships within the training dataset.

Next, the faithfulness evaluation technique generates a first similarity score that represents the similarity between the generated response and the one or more relevant content items and generates a second similarity score that represents the similarity between the parametric response and the one or more relevant content items. For example, the first and second similarity scores may be determined, as discussed previously, based on the semantic similarity between words by using a measurement function (e.g., a heuristic quantification method of keyword matching), such as cosine similarity, Euclidean distance, Manhattan distance, Jaccard similarity, and Minkowski distance. Next, the consistency score is generated based on a difference between the first similarity score and the second similarity score.

In some embodiments, one of the consistency measurement models may include a SCALE (Source Chunking Approach for Large-Scale Inconsistency Evaluation) technique (as described in B. Lattimer et al., “Fast and Accurate Factual Inconsistency Detection Over Long Documents,” arXiv:2310.13189v2 [cs.CL] 23 Oct. 2023, incorporated herein by reference), which is configured to detect factual inconsistencies within long-form text. Such SCALE technique may involve a SCALE machine learning model (which may be pretrained). For example, such SCALE machine learning model may be stored in the machine learning store 108 (and retrieved from the machine learning store 108 by the consistency evaluation module 106c). Facilitating the SCALE technique involves dividing the generated response into chunks. As discussed previously, each chunk may correspond to an (different) individual sentence in the one or more relevant content items. In another example, each chunk may correspond to a (fixed) predetermined number of tokens (e.g., 1, 2, 3 . . . 200, etc.).

Then, the chunks are input into the SCALE machine learning model, which identifies inconsistencies among the chunks. For example, the SCALE machine learning model may be trained to detect the relationship between two sentences (e.g., first sentence and second sentence), such as entailment (e.g., the first sentence implies the second sentence), contradiction (e.g., the first sentence contradicts the second sentence), and neutral (e.g., no relationship can be determine between the first sentence and the second sentence). Consequently, the SCALE machine learning model may generate a consistency score that includes the total number of inconsistencies detected.

At block 214, the consistency evaluation module 106c retrieves a scoring machine learning model from, for example, the machine learning store 108. For example, the scoring machine learning model may be a binary classification model that uses at least one of the following algorithms: naïve Bayes, logistic regression, k-nearest neighbors, support vector machine, decision tree, and neural networks. In addition, the scoring machine learning model may be pretrained to generate a final consistency score based on one or more consistency scores. At block 216, the scoring machine learning model generates a final consistency score based on the one or more consistency scores generated in, for example, block 212 of routine 200. In some embodiments, the scoring machine learning model is configured to generate a final consistency score that includes a numerical value that is between zero and one.

At block 218, the consistency evaluation module 106c determines whether the final consistency score reaches (e.g., greater than or equal to) a predetermined consistency threshold. In case that the final consistency score does not reach (e.g., is less than) the predetermined consistency threshold, (block 218, no) the routine moves to block 220. At block 220, the error correcting module 106e performs error correction in the generated response. For example, it is determined that the final consistency score is less than the predetermined consistency threshold, the consistency evaluation module 106c may transmit a communication (e.g., instruction) to cause (e.g., trigger) the error correcting module 106d to execute the error correction action on the generated response.

After receiving the communication (e.g., instruction), the error correction 106d may retrieve an error correcting machine learning model from, for example, the machine learning store 108. The error correcting machine learning model may be a small LLM (that has been fine-tuned). Next, the generated response and the one or more relevant content items are used as input into the error correcting machine learning model, which then generates a corrected response. The corrected response may be generated by having the error correcting machine learning model delete incorrect information (or words) in the generated response (e.g., “The Yankees are a <delete> Massachusetts <delete> sports team”) and insert correct information (or words) to the generated response (e.g., “The Yankees are a <mark> New York <mark> sports team”). Additionally, the error correction may also involve replacement of words and swaps of words.

In case that the final consistency score reaches (e.g., is greater than or equal to) the predetermined threshold (block 218 yes), the routine moves to block 222. At block 222, the error correcting module 106e performs a completeness evaluation. For example, it is determined that the final consistency score is greater than the predetermined consistency threshold, the consistency evaluation module 106c may transmit a communication (e.g., instruction) to cause (e.g., trigger) the completeness evaluation module 106e to determine whether the generated response is complete via a completeness score.

More specifically, the completeness score may indicate the extent to which the generated response addresses the user prompt, leaving no significant knowledge gaps or important aspects unaddressed (e.g., “Generated Response 1: A 401(k) plan is a retirement savings plan” vs. “Generated Response 2:“A 401(k) plan is a retirement savings plan offered by American employers” vs. “Generated Response 3: A 401(k) plan is a retirement savings plan offered by American employers that has tax advantages”). In some embodiments, the completeness score may also indicate at least one of semantic incompleteness (e.g., the generated response may lack depth or does not fully address the underlying user prompt), factual accuracy (e.g., the generate response may be factually incorrect and can perpetuate misinformation or outdated information) and context sensitivity (e.g., the failure of the generate response to maintain context due to long conversations or long input prompts).

After receiving the communication (e.g., instruction), the completeness evaluation module 106e may retrieve a completeness machine learning model from, for example, the machine learning store 108. The completeness machine learning model may be a large language model (LLM), such as Mistral 7B Instruct or the chat variant of LLaMA 2 7B. Next, the generated response and the one or more relevant content items are used as input into the completeness machine learning model, which then generates a completeness score. The completeness score may be a binary value that is either zero (e.g., indicates an incomplete generated response) or a one (e.g., indicates a completed generated response). In some embodiments, the completeness score is determined or measured (e.g., by the completeness machine learning model) via a scoring rubric, in which the scoring rubric indicates the degree to which the generated response addresses the user prompt. For example, a maximum rubric score on the scoring rubric indicates that a generated response completely addresses a user prompt in view of the one or more relevant content items.

At block 224, the quality evaluation module 106f performs a quality evaluation, in which the quality of the generated response is determined or evaluated. For example, after generating the completeness score, the completeness evaluation module 106e may transmit a communication (e.g., instruction) to cause (e.g., trigger) the quality evaluation module 106f to generate a quality score, which evaluates the quality of a generated response. More specifically, the quality score may represent the quality of the response in view of the user prompt and the one or more relevant content items.

For example, the quality score may indicate at least one of relevance (e.g., whether the generated response is relevant to both the user prompt and the one or more relevant documents), completeness (e.g., whether the generated response full addresses the user prompt by providing necessary information based on the one or more relevant content items without requiring further clarification), contextual alignment (e.g., whether the user prompt and the generated answer aligns with the context of the one or more relevant content items), clarity (e.g., whether the user prompt and/or the generate response is easy to understand from the perspective of the user), brevity (e.g., whether the generated response is as short as possible without omitting necessary information), coherence (e.g., whether the generated response logically corresponds to the user prompt), entities (e.g., whether the generated response includes all the relevant entities that are included within the one or more relevant content items), and ease of comprehension or readability (e.g., whether the generated response is readable from the perspective of an adolescence), with respect to the generate response.

To generate the quality score, the quality evaluation module 106f may retrieve a quality evaluating machine learning model from, for example, the machine learning store 108. The quality evaluating machine learning model may be a large language model, such as ChatGPT-4. For example, the quality evaluating machine learning model may determine the quality of the response based at least one of whether the generated response is relevant to the user prompt in view of the one or more relevant content items, whether the generated response is concise, whether important entities in the one or more relevant content items are included within the generated response, and whether generated response includes correct grammar.

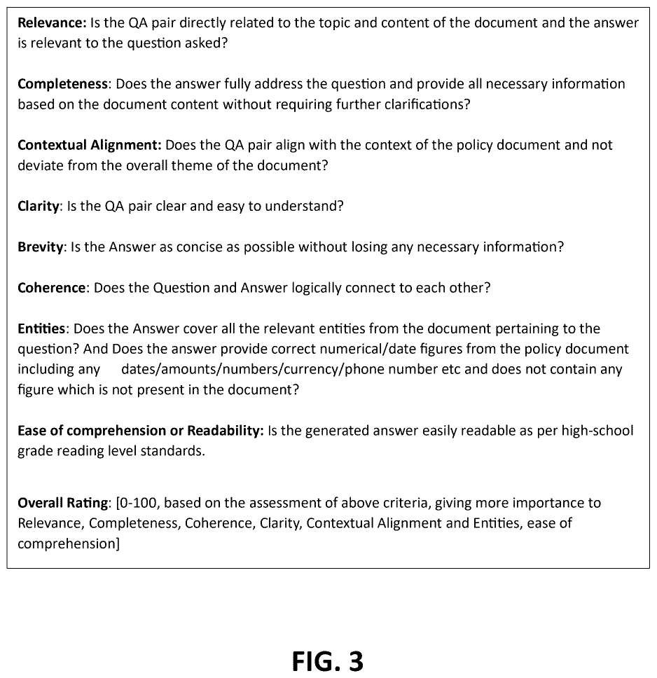

Next, the generated response, the one or more relevant content items, and a quality evaluation instruction are used as input into the quality evaluating machine learning model, which then generates a quality score. An example of the quality evaluation instruction is illustrated in FIG. 3. As shown, the quality evaluation instruction includes an instruction to generate an overall rating (e.g., 0-100) based on the assessment of one or more criteria (e.g., “Relevance: Is the QA pair directly related to the topic and content of the document and the answer is relevant to the question asked?”, “Clarity: Is the QA pair clear and easy to understand?”, etc.). The quality score may be considered the overall rating.

In some embodiments, the quality evaluation module 106f may utilize a Retrieval-Augmented Generation Assessment Suite (RAGAS) technique (as described in S. Es et al., “RAGAS: Automated Evaluation of Retrieval Augmented Generation,” arXiv:2309.15217v1 [cs.CL] 26 Sep. 2023, incorporated herein by reference), which may involve a machine learning model that may be used to implement the RAGAS technique (e.g., a RAGAS machine learning model). The RAGAS technique may be configured to evaluate how well a system is able to retrieve relevant content items, generate answers based on the content items (retrieved via RAG), and ensure that the retrieved content items are as relevant as possible. More specifically, the RAGAS technique may include one or more prompts (or instructions) that are arranged in a sequential structured manner, so as to allow the RAGAS machine learning model to generate one or more metrics. In some embodiments, the RAGAS technique additionally includes specific fine-tuning of machine learning models (e.g., LLMs) as well as other semantic measurement models. For example, the quality evaluation module 106f may retrieve a RAGAS machine learning model from, for example, the machine learning store 108. The RAGAS machine learning model may generate the one or more metrics based on the one or more prompts, the answer and the retrieved content items (e.g., retrieved via RAG). Such metrics include, but is not limited to, factual accuracy (e.g., how accurate the answer is with respect to the retrieved content items), relevance (e.g., the relevancy between the answer and the retrieved content items), and contextual precision (e.g., how effective it was to generate a coherent and informative answer based on the retrieved one or more content items).

It should be noted that, in some embodiments, the completeness evaluation (e.g., in block 222) and the quality evaluation (e.g., block 224) can be performed simultaneously. For example, after it is determined that the final consistency score is greater than the predetermined consistency threshold, the consistency evaluation module 106c may transmit a communication (e.g., instruction) to cause (e.g., trigger) both the completeness evaluation module 106e and the quality evaluation module 106f to execute their respective actions. In some embodiments, the quality evaluation (e.g., block 224) is performed before the completeness evaluation (e.g., in block 222). For example, after generating the quality score, the quality evaluation module 106f may transmit a communication (e.g., instruction) to cause (e.g., trigger) the completeness evaluation module 106e to generate the completeness score.

It should also be noted that, in some embodiments, after the error correction is performed to generate a corrected response (e.g., in block 220 of routine 200 in FIG. 2), the corrected response may further be evaluated by at least one of the completeness evaluation module 106e and the quality evaluation module 106f. For example, the error correcting module 106d may transmit a communication (e.g., instruction) to cause (e.g., trigger) at least one of the completeness evaluation module 106e and the quality evaluation module 106f to execute their respective actions. In other words, the process moves from block 220 to at least one of block 222 and block 224. As discussed previously, the actions in block 222 may be executed before block 224 or the actions in block 224 may be executed before block 224. Likewise, the actions block 222 and block 224 may be executed simultaneously.

At block 226, the routine ends. In some embodiments, the generated response may be transmitted for viewing by a user (e.g., via a user interface) after the actions associated with block 220 have been performed (e.g., the generated response has been corrected). In some embodiments, the generated response may be transmitted for viewing by a user (e.g., via a user interface) after it is determined that a completeness score (e.g., generated in block 222) has reached a predetermined completeness threshold and a quality score (e.g., generated in block 224) has reached a predetermined quality threshold. For example, as discussed previously, the completeness score may be a binary value of one or zero. Therefore, the predetermined completeness threshold may have a value of one. In another example, discussed previously, the quality score may be between one and one-hundred (inclusive). Therefore, the predetermined quality threshold may be a value between one and one-hundred (exclusive).

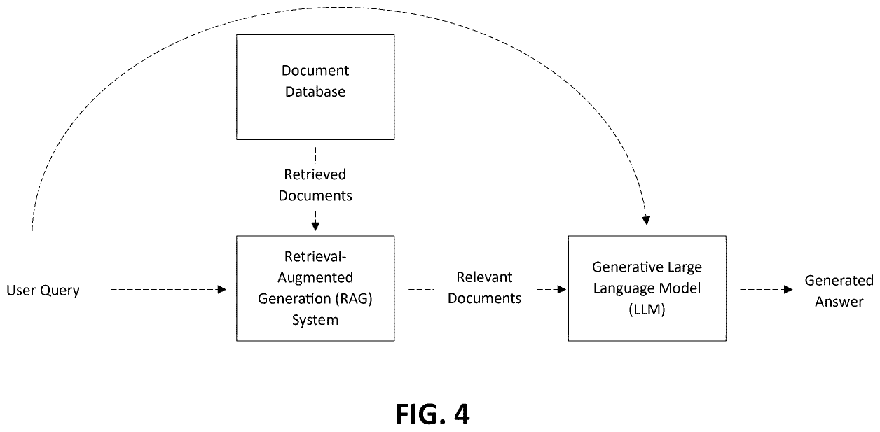

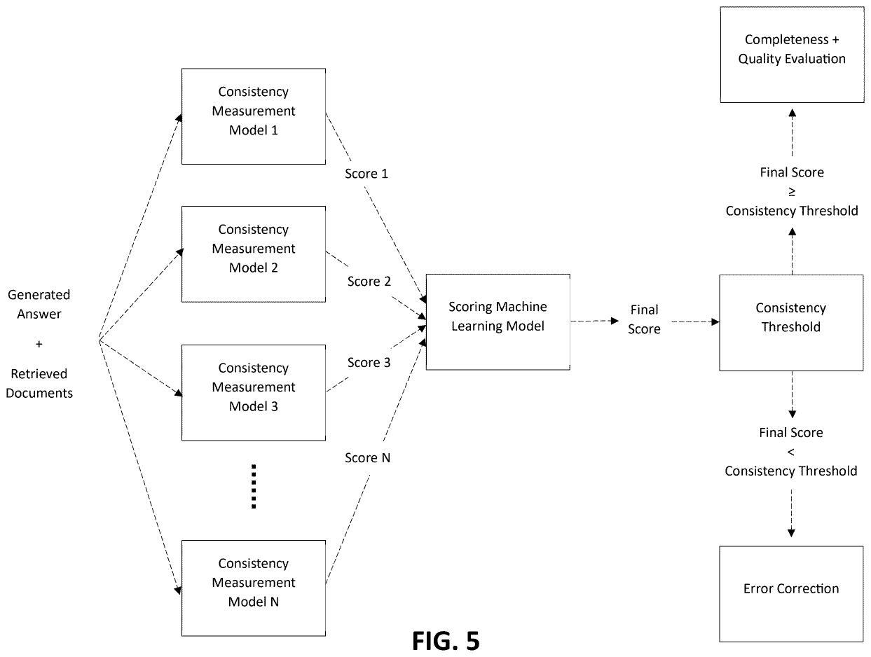

It should also be noted that the process in FIG. 2 is also illustrated in FIG. 4 and FIG. 5 (with slight modifications) that may be implemented in some embodiments. As shown in FIG. 4, a user prompt in the form of a user query is used as input into a retrieval augmented generation (RAG) system as well as into a generative large language model (LLM). For example, a user interface that receives the user prompt may transmit the user prompt to both the RAG system and the generative LLM simultaneously.

The RAG system may be configured to retrieve documents (or any other media, such as text, images, audio, video, or a combination thereof) from a document database. The RAG system may utilize any of the aforementioned techniques for determining one or more relevant documents based on the semantic similarity between the embedded user query and the one or more embedded documents that are stored in the document database. The generative LLM may be a machine learning model (e.g., pre-trained on a large dataset) that is configured to generate responses in a natural language format. After determining the one or more relevant documents, the RAG system may transmit the one or more relevant documents to the generative LLM. Next, the generative LLM may generate a generated answer based on the user query and the one or more relevant documents.

As illustrated in FIG. 5, the generated answer and the retrieved documents are used as input into one or more consistency measurement models 1-N (wherein N may be a natural number or an integer greater than zero). In some embodiments, each of the one or more consistency measurement models 1-N may be a consistency machine learning model (e.g., SummaC, AlignScore, SCALE, any version of ChatGPT, CoPilot, Gemini, Claude, etc.). In other embodiments, each of the one or more consistency measurement models 1-N may be a metric evaluation model (e.g., ROUGE-L). As discussed previously, the metric evaluation models may be models that determine a factual consistency of generated response via techniques that do not involve artificial intelligence (AI) or machine learning. In further embodiments, each of the one or more consistency measurement models 1-N may include one or more consistency machine learning models and one or more metric evaluation models.

Next, each of the consistency measurement models 1-N generate corresponding scores 1-N (wherein N may be a natural number or an integer greater than zero). The scores 1-N are used as input into a scoring machine learning model. The scoring machine learning model may be a binary classification model that uses at least one of the following algorithms: naïve Bayes, logistic regression, k-nearest neighbors, support vector machine, decision tree, and neural networks. In addition, the scoring machine learning model may be pretrained to generate a final score based on one or more scores.

Once the final score is generated by the scoring machine learning model, it is determined whether the final score reaches (e.g., is greater than or equal to) the predetermined consistency threshold. In case that the final score is greater than the consistency threshold, a completeness and quality evaluation is performed on the generated response (as discussed previously with respect to blocks 222 and 224 of routine 200 of FIG. 2). On the other hand, in case that the final score is less than consistency threshold, an error correction process is performed on the generated response (as discussed previously with respect to block 220 of routine 200 of FIG. 2). The modification of the respective correct answer to include one or more errors is performed by prompting at least one of a language model or a large language model to generate a hallucinated or factually inconsistent answer based on the correct answer.

### Example Routine for Training Machine Learning Model to Perform Error Correction

When a routine described herein (i.e., 200, 600, 800) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 900 shown in FIG. 9, and executed by one or more processors. In some embodiments, the routine 200, 600, 800, or portions thereof may be implemented on multiple processors, serially or in parallel.

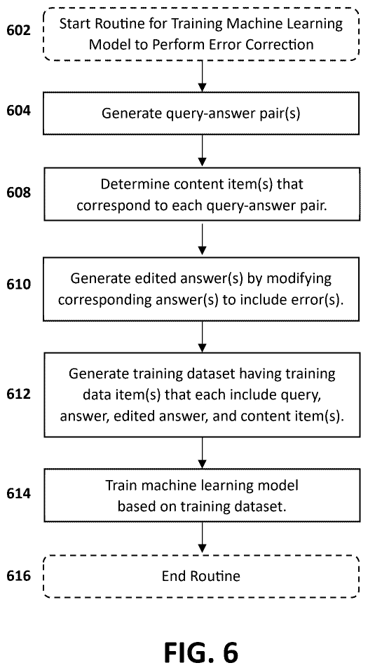

FIG. 6 illustrates example routine 600 (beginning at block 602) for training a machine learning model to perform error corrections. For example, the machine learning model may correspond to the machine learning model used by the error correcting module 106d (e.g., error correcting machine learning model). Further, as discussed previously, the error correcting machine learning model may be a small LLM (e.g., that is pretrained). As a result, the training performed in the routine 600 may be considered fine-tuning the error correcting machine learning model.

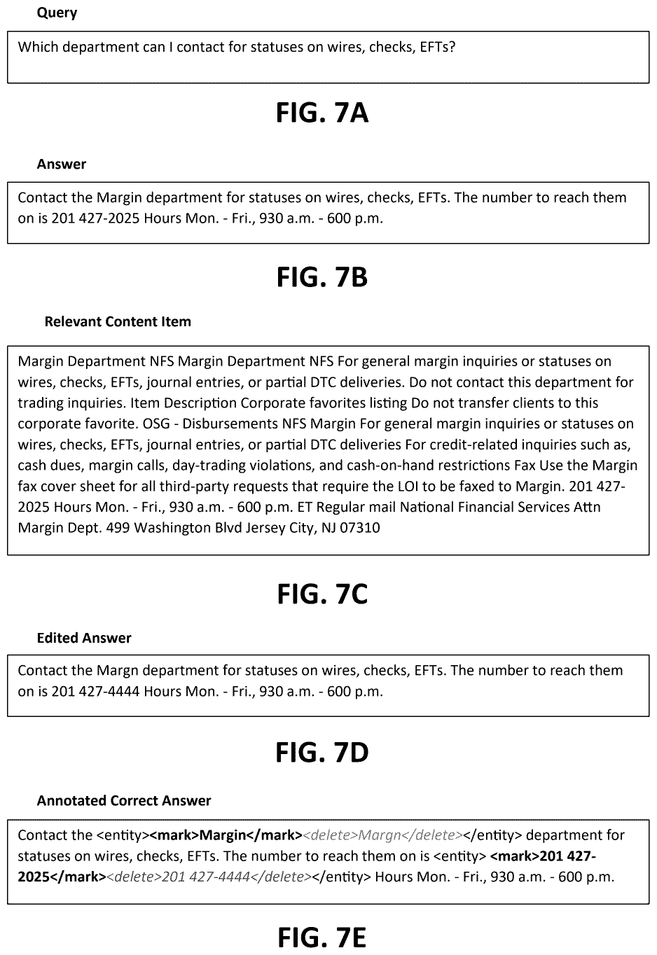

At block 604, one or more query-answer pair(s) are generated. The query-answer pairs may include a query (e.g., prompt) and the (correct) answer to the query. An example of a query is shown in FIG. 7A (“Which department can I contact for statuses on wires, checks, and ETFs?”). An example of the corresponding answer is shown in FIG. 7E (“Contact the Margin department for statuses on wires, checks, EFTs. The number to reach them on is 201 427-2025 Hours Mon.-Fri., 930 a.m.-600 p.m.”). It should be noted that the query may be in the form of a question. It should also be noted that that the query may be in the form other than a question, such as, for example, the imperative mood (e.g., “Please tell me which team has won the Stanley Cup the most”).

At block 608, one or more content items that correspond to each query-answer pair are determined. The answer to the query may be determined based on the one or more content items (e.g., query: “How many sick days do employees get?”; correct answer: “Employees get five sick days”; content item: employee handbook). An example of a relevant content item is illustrated FIG. 7C. As shown, the relevant content item includes information that is relevant to the query of FIG. 7A, and forms the basis for the answer in FIG. 7B.

At block 610, one or more edited answers are generated by modifying the corresponding one or more answers in the one or more query-answer pairs to include one or more errors. In other words, each answer in the one or more query-answer pairs is modified to generate a corresponding edited answer. For example, as illustrated in FIG. 7C, one or more words of the answer may be modified to include typographical errors, such as spelling errors (e.g., margin vs. margn), or grammatical errors (e.g., incorrect use of word, incorrect capitalization, missing punctuation, incorrect verb conjugation, incorrect positioning of adjectives or prepositions, etc.).

In addition, as is also shown in FIG. 7C, one or more pieces of information in the answer may be modified to include incorrect information (e.g., incorrect information: 201 427-4444 vs. correct information: 201 427-2025). In some embodiments, modification of answer to include one or more errors is performed by prompting an (error generating) machine learning model (e.g., a language model or an LLM) to generate an edited answer (e.g., that includes at least one of typographical errors, grammatical errors, hallucinations, factual inconsistencies, etc.) based on the answer in the query-answer pair. For example, the input to the error generating machine learning model may include the answer in the query-answer pair.

At block 612, a training dataset is generated, in which the training dataset includes one or more training data items that each include at least one of a query, answer, edited answer, and one or more relevant content items. The instruction may be a request to generate a correct answer based on an edited answer. The one or more relevant items in a training data item may form the basis for the (correct) answer to the query. At block 614, the machine learning model is trained (or fine-tuned) according to the training dataset. At block 616, the routine ends.

It should be noted that an example of an annotated correct answer is shown in FIG. 7E. More specifically, the annotated correct answer may be generated by the error correcting machine learning model during inference time (e.g., at block 220 of routine 200 of FIG. 2) in a hypothetical scenario in which the error correcting machine learning model was instructed to correct the answer in FIG. 7B (corresponding to the query in FIG. 7A) in view of the relevant content item of FIG. 7C. As illustrated in FIG. 7E, the edited answer has been corrected via annotations. More specifically, each entity that is incorrect (e.g., whether due to typographical errors, grammatical errors, or incorrect information) is identified via a tag having angled brackets (e.g., “<entity> </entity>”).

Within the entity tags is information on how to fix the errors. For example, the incorrect spelling of margin has been designated for deletion via “delete” tags having angled brackets (e.g., “<delete>Margn</delete>”) and a replacement text having the correct spelling of margin is inserted instead via “insert” or “mark” tags having angled brackets (e.g., “<mark>Margin</mark>”). Likewise, the incorrect information in the form of an incorrect telephone number has been designated for deletion “delete” tags having angled brackets (e.g., “<delete>201 427-4444</delete>”) and a replacement text having the correct information (e.g., correct telephone number) is inserted instead via “insert” or “mark” tags having angled brackets (e.g., “<mark>201 427-2025</mark>”). In some embodiments, the content within the delete tags (including the delete tags themselves) are removed and the insert tags are removed before the annotated correct answer is shown to the user (e.g., via a user interface).

### Example Routine for Training Machine Learning Model to Evaluate Completeness

When a routine described herein (i.e., 200, 600, 800) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 900 shown in FIG. 9, and executed by one or more processors. In some embodiments, the routine 200, 600, 800, or portions thereof may be implemented on multiple processors, serially or in parallel.

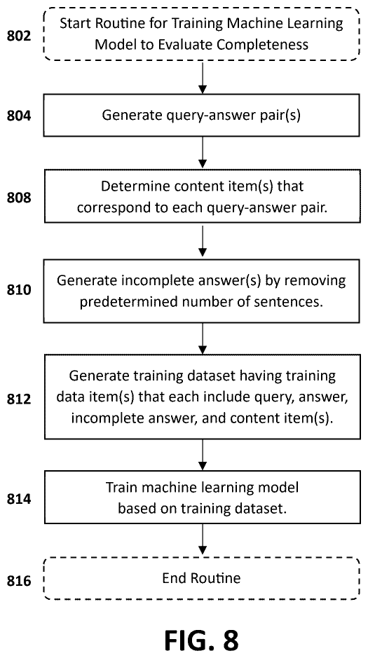

FIG. 8 illustrates example routine 800 (beginning at block 802) for training a machine learning model to evaluate completeness. For example, the machine learning model may correspond to the machine learning model used by the completeness evaluation module 106e (e.g., completeness machine learning model). Further, as discussed previously, the completeness machine learning model may be an LLM (e.g., that is pretrained), such as Mistral 7B Instruct or the chat variant of LLaMA 2 7B. As a result, the training performed in the routine 800 may be considered fine-tuning the completeness machine learning model.

At block 804, one or more query-answer pair(s) are generated. As discussed previously, a query-answer pair may include a query (e.g., prompt) and the (correct) answer to the query. An example of a query is shown in FIG. 7A (“Which department can I contact for statuses on wires, checks, and ETFs?”). An example of the corresponding answer is shown in FIG. 7E (“Contact the Margin department for statuses on wires, checks, EFTs. The number to reach them on is 201 427-2025 Hours Mon.-Fri., 930 a.m.-600 p.m.”).

At block 808, one or more content items that correspond to each query-answer pair are determined. The answer to the query may be determined based on the one or more content items (e.g., query: “How many sick days do employees get?”; correct answer: “Employees get five sick days”; content item: employee handbook). An example of a relevant content item is illustrated FIG. 7C. As shown, the relevant content item includes information that is relevant to the query of FIG. 7A, and forms the basis for the answer in FIG. 7B.

At block 810, one or more edited answers are generated by modifying the corresponding one or more answers in the one or more query-answer pairs to remove a predetermined number of sentences. In other words, each answer in the one or more query-answer pairs is modified to generate a corresponding incomplete answer. For example, a certain percentage (e.g., 25%, 30%, 40%, etc.) of sentences in each answer of the query-answer pairs may be removed. In some embodiments, the sentences are randomly removed from the answer. In some embodiments, the removed sentences are contiguous (e.g., each of removed sentences follow from one another). In some embodiments, the removed sentences are not contiguous (e.g., each of removed sentences do not follow from one another). In some embodiments, there may be a set of remove sentences that may be contiguous and a set of removed sentences that may not be contiguous.

At block 812, a training dataset is generated, in which the training dataset includes one or more training data items that each include at least one of an instruction, scoring rubric, query, answer, one or more relevant content items, and the incomplete answer. The instruction may correspond to a request to generate a rubric score for the incomplete answer. More specifically, the scoring rubric may include one or more rubric scores that each indicate the degree to which the incomplete answer addresses the user prompt. In some embodiments, a rubric score corresponding to the incomplete answer is included in each training item. In some embodiments, the one or more rubric scores are on a range values (e.g., not binary). In other embodiments, the one or more rubric scores each include binary values (e.g., zero or one). In some embodiments, the machine learning model is fine-tuned using Parameter-Efficient Fine-Tuning (PEFT) and Quantized Low Rank Adapters (QLoRA). At block 814, the machine learning model is trained (or fine-tuned) according to the training dataset. At block 816, the routine ends. It should be noted that the completeness score generated at inference time (e.g., block 222 of routine 200 of FIG. 2), may correspond to the rubric score provided during training time (e.g., routine 800 of FIG. 8).

### Execution Environment

FIG. 9 illustrates various components of an example computing device 900 configured to implement various functionality described herein.

In some embodiments, the computing device 900 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provide by the computing device 900 may be implemented as webs services consumable via one or more communication networks. In further embodiments, the computing device 900 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 900 may include one or more processors 902, such as physical central processing units (“CPUs”); one or more network interfaces 904, such as network interface cards (“NICs”); one or more computer readable medium drives 906, such as a high density disk (“HDDs”), solid state drives (“SSDs”), flash drives, and/or other persistent computer readable media; one or more input/output drive interfaces 908; and one or more computer-readable memories 910, such as random access memory (“RAM”) and/or other volatile non-transitory readable media. The one or more computer-readable memories 910 may include computer program instructions that one or more computer processors 902 execute and/or data that the one or more computer processors 902 use in order to implement one or more embodiment. For example, the one or more computer-readable memories 910 can store an operating system 912 to provide general administration of the computing device 900.

As another example, the one or more computer-readable memories 910 can store a response generating module 914 (e.g., response generating module 106a) for generating response (e.g., via a machine learning model) based on a user prompt and one or more relevant content items retrieved from a content database. In another example, the one or more computer-readable memories 910 can store a content retrieval module 916 (e.g., content retrieval module 106b) for retrieving one or more relevant content items from a content database that are relevant to the user prompt. In a further example, the one or more computer-readable memories 910 can store a consistency evaluation module 918 (e.g., consistency evaluation module 106c) for determining a (factual) consistency of a response that is generated by a machine learning model. In yet another example, the one or more computer-readable memories 910 can store an error correcting module 920 (e.g., error correcting module 106d) for correcting errors in a response that is generated by a machine learning model. In yet a further example, the one or more computer-readable memories 910 can store an error completeness evaluation module 922 (e.g., completeness evaluation module 106e) for determining whether a response (that is generated by a machine learning model) is complete. In another example, the one or more computer-readable memories 910 can store a quality evaluation module 924 (e.g., quality evaluation module 106f) for determining the quality of a response that is generated by a machine learning model.

In addition, the one or more computer-readable memories 910 can store machine learning model(s) 926 (e.g., machine learning store 108) that may include machine learning model(s) such as classification type machine learning model(s), regression type machine learning model(s), support vector machines (SVM) machine learning model(s), ensemble method machine learning model(s), neural network model(s), recurrent neural networks (e.g., long short term memory), deep learning model(s), or (large) language model(s). For example, the large language models may include, but is not limited to, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (large Language Model Meta AI), BigScience Large Open-science Open-access Multilingual Language Model (BLOOM), Mistral 7B Instruct, and the chat variant of LLaMA 2 7B.

In a further example, the one or more computer-readable memories 910 can store metric evaluation models 928 (e.g., metric evaluation store 110) that may include metric evaluation model(s), which are models that determine a (factual) consistency of generated response via techniques that do not involve artificial intelligence (AI) or machine learning. For example, a metric evaluation model may include ROUGE-L (Recall-Oriented Understudy for Gisting Evaluation-Longest Common Subsequence) technique.

### Terminology

The term “model,” as used in the present disclosure, can include computer-based models of any type and of any level of complexity, such as any type of sequential, functional, or concurrent model. Models can further include various types of computation models, such as, for example, artificial neural networks (“NN”), language models (e.g., large language models (“LLMs”)), artificial intelligence (“AI”) models, machine learning (“ML”) models, multimodals (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language response based on the text on which the model is trained. A language model may include n-gram, exponential, positional, neural network, and/or other types of models.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise an NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic process. Similarly, while certain aspects and implementations are discussed herein with reference to use of a ML model, those aspects and implementations may be performed any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“API's”), and/or any combination of the foregoing and/or the like. Additionally, in various implementations, the LLMS and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3(GPT-3), Generative Pre-trained Transformer 4 (GPT-4), LLaMA (large Language Model Meta AI), and BigScience Large Open-science Open-access Multilingual Language Model (BLOOM).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computing system for determining accuracy of natural language responses generated by a machine learning model, the system comprising a server computing device having a memory for storing computer-executable instructions and a processor that executes the computer-executable instructions to:
generate, by a generative machine learning model, a response, in the natural language, to a user prompt from a user, wherein the generated response is generated based on the user prompt and one or more content items, and wherein the one or more content items are determined by a retrieval machine learning model to be relevant to the user prompt;
generate, via two or consistency more machine learning models, two or more consistency scores, wherein the two or more consistency scores are each generated by a different consistency machine learning model based on at least one of the user prompt, the response, and the one or more content items, wherein each consistency score represents a different consistency measurement of the response according to the respective consistency machine learning model;
generate, via a scoring machine learning model, a final consistency score based on the two or more consistency scores; and
determine that the response is accurate in the case that the final consistency score is greater than or equal to a consistency predetermined threshold.

2. The computing system of claim 1, wherein the computer-executable instructions cause the processor to perform further operations to:
generate, via a completeness machine learning model, a completeness score based on the user prompt, the response, and the one or more content items, wherein the completeness score represents the extent to which the response addresses the user prompt in view of the one or more content items; and
transmit the response to the user in a case that the completeness score is equal to or greater than a completeness predetermined threshold.

3. The computing system of claim 1, wherein the completeness score is measured via a scoring rubric, in which the scoring rubric includes one or more rubric scores that indicate the degree to which the response addresses the user prompt, and wherein a maximum rubric score on the scoring rubric indicates that a response completely addresses a user prompt in view of relevant one or more content items.

4. The computing system of claim 2, wherein the completeness machine learning model is trained using a training dataset that includes reference content items, one or more prompts corresponding to the one or more reference content items, and one or more incomplete answers that each correspond to a complete answer to a prompt of the one or more prompts, wherein each incomplete answer is generated by removing one or more contiguous sentences in a respective complete answer.

5. The computing system of claim 2, wherein the completeness machine learning model includes at least one of Large Language Model Meta AI (Llama) 2 and Mistral.

6. The computing system of claim 2, wherein the machine learning model is fine-tuned using at least one of Parameter-Efficient Fine-Tuning (PEFT) and Quantized Low Rank Adapters (QLoRA).

7. The computing system of claim 2, wherein in a case that the final consistency score is less than a consistency predetermined threshold, the computer executable instructions cause the processor to perform further operations to:
generate, via an error correcting machine learning model, a corrected response based on the edited response and the one or more content items, wherein the corrected response corrects one or more errors in the edited response; and
transmit the corrected response to the user.

8. The computing system of claim 7, wherein the error correcting machine learning model is trained using a training dataset that includes one or more reference content items, one or more prompts that correspond to the one or more reference content items, and one or more erroneous answers that each correspond to a correct answer to a prompt of the one or more prompts, and wherein each of the one or more erroneous answers are generated based by modifying the respective correct answer to include one or more errors.

9. The computing system of claim 8, wherein modifying the respective correct answer to include one or more errors comprises at least one of insertion of words, deletion of one or more words, replacement of one or more words, and swaps of one or more words.

10. The computing system of claim 9, wherein the modification of the respective correct answer to include one or more errors is performed by prompting at least one of a language model or a large language model to generate a hallucinated or factually inconsistent answer based on the correct answer.

11. The computing system of claim 1, wherein the computer-executable instructions cause the processor to perform further operations to:
generate, via a quality control machine learning model, a quality score based on the user prompt, the response, and the one or more content items, wherein the quality score represents the quality of the response in view of the user prompt and the one or more content items; and
transmit the response to the user in a case that the completeness score is equal to or greater than a completeness predetermined threshold.

12. The computing system of claim 11, wherein the quality control machine learning model determines the quality of the response based at least one of whether the response is relevant to the user prompt in view of the one or more content items, whether the response is concise, whether important entities in the one or more content items are included within the response, and whether response includes correct grammar.

13. A computerized method for determining accuracy of natural language responses generated by a machine learning model, the method comprising:
generating, by a server computer device using a generative machine learning model, a response, in the natural language, to a user prompt from a user, wherein the response is generated based on the user prompt and one or more content items, and wherein the one or more content items are determined by a retrieval machine learning model to be relevant to the user prompt;
generating, by the server computer device using two or consistency more machine learning models, two or more consistency scores, wherein the two or more consistency scores are each generated by a different consistency machine learning model based on at least one of the user prompt, the response, and the one or more content items, wherein each consistency score represents a different consistency measurement of the response according to the respective consistency machine learning model;
generating, by the server computer device using a scoring machine learning model, a final consistency score based on the two or more consistency scores; and
determining, by the server computer device, that the response is accurate in the case that the final consistency score is greater than or equal to a consistency predetermined threshold.

14. The computerized method of claim 13, wherein the retrieval machine learning model uses the retrieval augmented generation (RAG) technique in retrieving the one or more content items from a content database.

15. The computerized method of claim 13, wherein at least one of the two or more consistency machine learning models determines a consistency score by:
determining whether it is possible to generate an answer to the user prompt;
generating a test response based on the user prompt and the one or more content items after determining that it is possible to generate an answer to the user prompt; and
generating the consistency score based on an overlap measurement that represents the amount of overlap between the response and the test response.

16. The computerized method of claim 13, wherein at least one of the two or more consistency machine learning models determines a consistency score by:
determining the longest common subsequence between the response and the one or more content items, wherein the longest commons subsequence includes the longest sequence of words that are present in both the response and the one or more content items;
generating a precision metric and a recall metric based on the longest common subsequence and the total number of words in the response and the total number of words in the one or more content items; and
generating the consistency score based on a harmonic mean of the precision metric and the recall metric.

17. The computerized method of claim 13, wherein at least one of the two or more consistency machine learning models determines a consistency score by:
generating a matrix that includes, for each element in the matrix, an entailment score that corresponds to one or more combinations of sentences in the response and the one or more content items, wherein the rows of the matrix correspond to one or more sentences in the one or more content items and the columns of the matrix correspond to one or more sentences in the response, and wherein each combination includes a sentence from the response and a sentence from the one or more content items;
determining a maximum score set that includes a maximum score for each column in the matrix; and
generating a consistency score based on the average of the maximum scores in the maximum score set.

18. The computerized method of claim 13, wherein at least one of the two or more consistency machine learning models determines a consistency score by:
dividing the one or more content items into one or more chunks;
dividing the response into one or more sentences;
generating one or more alignment scores for one or more combinations of the one or more chunks and the one or more individual sentences, wherein each combination includes a chunk from the one or more chunks and a sentence from the one or more individual sentences, and wherein each alignment score is generated by inputting an alignment machine learning model with a respective combination; and
generating the consistency score based on the average of the one or more alignment scores.

19. The computerized method of claim 13, wherein at least one of the two or more consistency machine learning models determines a consistency score by:
generating, by the generating machine learning model, a parametric response based on the user prompt and parametric knowledge stored in the generating machine learning model;
generating a first similarity score that represents the similarity between the response and the one or more content items and a second similarity score that represents the similarity between the parametric response and the one or more content items; and
generating the consistency score based on a difference between the first similarity score and the second similarity score.

20. The computerized method of claim 13, wherein the two or more consistency machine learning models includes at least one of Bidirectional and Auto-Regressive Transformers (BART), Text-to-Text Transfer Transformer (T5), Source Chunking Approach for Large-Scale Inconsistency Evaluation (SCALE), Summary Consistency Detection (SummaC), and AlignScore.

21. The computerized method of claim 13, wherein the scoring machine learning model is configured to generate a final score that includes a numerical value that is between zero and one.

22. The computerized method of claim 13, wherein the scoring machine learning model is a binary classification model that uses at least one of the following algorithms: naïve Bayes, logistic regression, k-nearest neighbors, support vector machine, decision tree, and neural networks.

23. The computerized method of claim 13, wherein at least one of the retrieval machine learning model, the generative machine learning model, and the two or more consistency machine learning models includes at least one of a language model or a large language model.

24. The computerized method of claim 13, wherein the generative machine learning model includes at least one of ChatGPT, CoPilot, Gemini, Claude, Mistral, Llama, and Phi.
